(19) United States
(12) Patent Application Publication
(10) Pub. No.: US 2001/0041111 A1
(43) Pub. Date: Nov. 15, 2001

(54) FASTENER WITH MEANS FOR INDICATING IF TOO MUCH MATERIAL HAS BEEN REMOVED FROM THE HEAD OF THE FASTENER AND METHOD FOR SHAVING SAME.

(76) Inventor: CHARLES R. SMITH, MESA, AZ (US)

Correspondence Address: CHARLES E CATES, CATES & HOLLOWAY, P.O. BOX 1532, SCOTTSDALE, AZ, 85252-1532, US

(21) Appl. No.: 09/394,281

(22) Filed: Sep. 10, 1999

Related U.S. Application Data
(60) Provisional application No. 60/099,833, filed on Sep. 11, 1998.

(51) Int. Cl. F16B 35/00; F16B 23/00

(52) U.S. Cl. 411/394

(57) ABSTRACT

The fastener of the present invention is made to be shaved flush with a surface. The fastener is made such that some visually or mechanically detectable indicator reveals if too much material has been removed from the head of the fastener during the shaving process. The fastener and its method of use contemplates several means of indicating if too much material has been removed from the head of the fastener. These means include either tightly controlling the height of the fastener head or adding features to the head, land, or countersink of the fastener which indicate if an excessive amount of material has been removed.

This Non-Provisional Application claims the benefit of U.S. Provisional Application Serial No. 60/099,833 filed on Sep. 11, 1998. This invention relates to a fastener that has features or color changes that indicate if too much material has been removed by shaving and method of using same.

The U.S. Government has a paid-up license in this invention and the right in limited circumstances to require the patent owner to license others on reasonable terms as provided for by the terms of contract No. F04606-96-C-0098 awarded by the U. S. Air Force.

### BACKGROUND OF THE INVENTION

In some industries, such as the aerospace industry, it is desirable to have flush structural fasteners. Such fasteners improve aerodynamic efficiency and aesthetic appearance. In industries such as the aerospace industry, high strength fasteners are also desirable. Although fasteners can be manufactured to reflect the typical height tolerances of the countersink holes, some errors in manufacturing the fasteners or drilling the countersink holes may occur. Thus, it is difficult to manufacture fasteners that will be initially flush with the surface to be joined without some alteration to the fastener.

For many years, high strength fasteners that could be made flush with a surface proved to be a difficult combination to achieve. One solution to this problem is disclosed in U.S. Pat. No. 4,979,281. That patent teaches a readily deformable layer of material joined to the top of a fastener head. The body of the fastener is then formed of a plastic or matrix material that is harder and/or has a higher melting point than the material bonded to the head of the fastener. Patent '281 teaches forming a countersink hole, placing the fastener in the countersink hole, and then deforming the top layer of deformable material so that any gaps between the countersink hole and the fastener head are filled. Any excess material is then removed by sanding, chiseling, shaving, or the like to make the fastener flush with the surface.

Although the invention taught by '281 does result in a flush surface, there remain several unresolved problems. First, '281 teaches no method of determining if the fastener has been weakened by removing too much material from its head. Further, even though the body of the fastener taught by '281 is of a high strength material, the material joined to the head of the fastener must necessarily be of a lower strength material. Thus, the overall strength of the fastener is reduced. Additionally, joining the layer of deformable material to the head of the fastener adds an additional step to the manufacturing process of the fastener. Another disadvantage in the fastener taught by '281 is that the fastener head, which is made of lower strength material, is able to tolerate only a rather low amount of shear before the body of the fastener will come apart from the material joined to its head. Thus, it is difficult to use the fastener of '281 with a wrenching device or any other torque inducing instrument.

In the past, having a layer of deformable material on the top of the fastener was the only commercially practicable means for making the fastener surface flush against a structure's surface. However, as shaving equipment has improved, it has become feasible to shave high strength materials such as titanium. With these advances in high strength shavers, it is now possible to have fasteners made entirely of titanium or other high strength materials, because such fasteners can now be shaved down to create an aerodynamically smooth surface. However, if there is a mismatched fastener and countersink hole, such shavers may remove too much material from the fastener head and thereby weaken the structural integrity of the fastener.

### BRIEF SUMMARY OF THE INVENTION

The present invention recognizes the problem of inadvertently removing too much material from the head of a fastener and contemplates devices and methods for avoiding or identifying such situations. This object is accomplished by means of indicators integrated into the head and body of the fastener which indicate, either by visual or mechanical means, if too much material has been removed from the fastener head in the shaving process used to make the fastener flush with a structure's surface. For the purposes of this application and as applied in the relevant art, “flush” is understood to mean shaving the fastener even with the plane of the structural element to be joined to the degree possible using commercially available machining processes. “Flush” is also understood to mean conforming to any curvature of the structural element to be joined. The fastener of the present invention is considered “flush” even though certain depressions or other features may remain detectable in the shaved head of the fastener. Further, for purposes of this application, “shaving” is understood to mean removing material from the fastener head by any commercially available machining process, including cutting, shaving, abrading, or sanding.

The fastener of the present invention has a head portion and a shank portion. The head portion comprises a top, a land, and a countersink. A portion of the head is made available to be shaved flush with a surface, and the fastener carries an indicator in its head which reveals if too much material has been removed from the fastener by shaving. The fastener of the present invention contemplates several means of indicating if too much material has been removed from the head of the fastener. These means include either (1) tightly controlling the height of the fastener land or (2) adding features to the top, land, or countersink of the fastener which indicate if an excessive amount of material has been removed. If too much material has been removed from the head of the fastener, the structural integrity of the fastener is weakened, and the fastener should be discarded and another one inserted in its place.

### BRIEF DESCRIPTION OF THE SEVERAL VIEWS OF THE DRAWINGS

FIG. 1A is an elevational view of the fastener of the present invention.

FIG. 1B is a sectional viewtaken along line 1B-1B of FIG. 1A showing a layer of material joined to the head of the fastener.

FIG. 2A is a top view of the fastener of the present invention inserted into a countersink hole in the structural element to be joined.

FIG. 2B is a sectional view of the fastener of the present invention taken along line 2B-2B of FIG. 2A showing the fastener inserted into the countersink hole formed in the structural elements of be joined.

FIG. 2C is a sectional view of the fastener of the present invention showing the fastener inserted into the countersink hole formed in the structural elements of be joined and shaved flush with the top surface of the structural element.

FIG. 3 is a sectional view of the embodiment of the present invention in which the land height is carefully controlled.

FIG. 4A is a sectional view of the embodiment of the present invention in which a depression or depressions are formed in the top surface of the fastener.

FIG. 4B is a sectional view of the embodiment of the present invention in which a depression or depressions are formed in the surface of the material joined to the body of the fastener.

FIG. 4C is a sectional view of the embodiment of the present invention in which a depression or depressions are formed in the body of the fastener below material joined to the body of the fastener.

FIG. 5 is a sectional view of the embodiment of the present invention in which a central depression in the form of a tap root is made in the top surface of the fastener.

FIG. 6 is a sectional view of the embodiment of the present invention in which a depression or depressions are added to the countersink.

FIG. 7 is a sectional view of the embodiment of the present invention in which a machinable material of a different color or texture is installed on the head of the fastener.

FIG. 8 is a perspective view of the embodiment of the present invention in which the fastener is formed to incorporate a wrenching device.

### DETAILED DESCRIPTION OF THE INVENTION

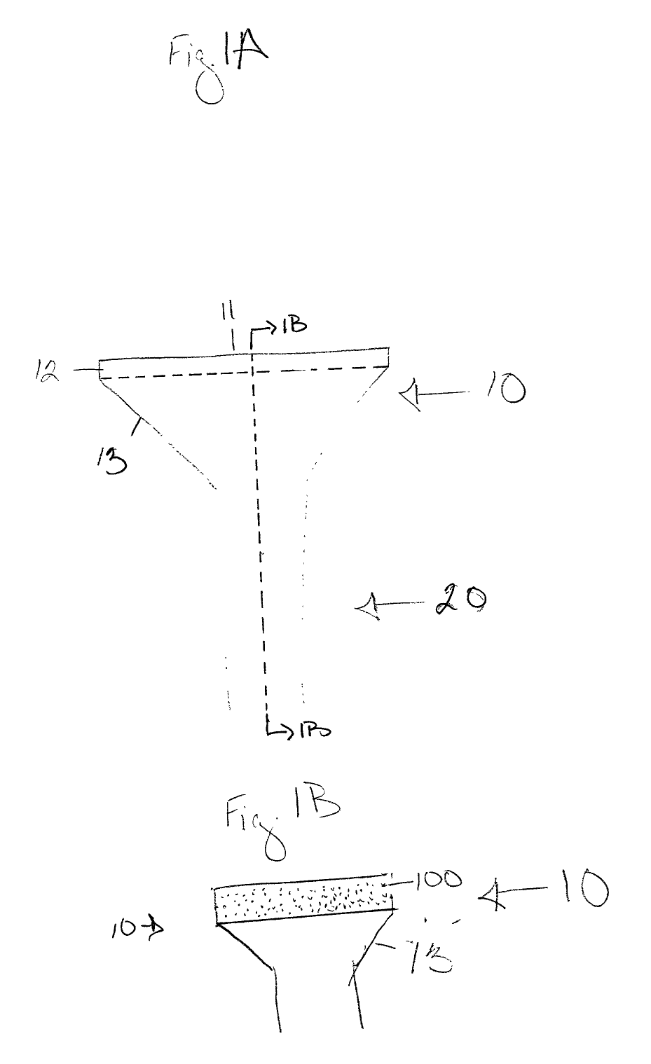

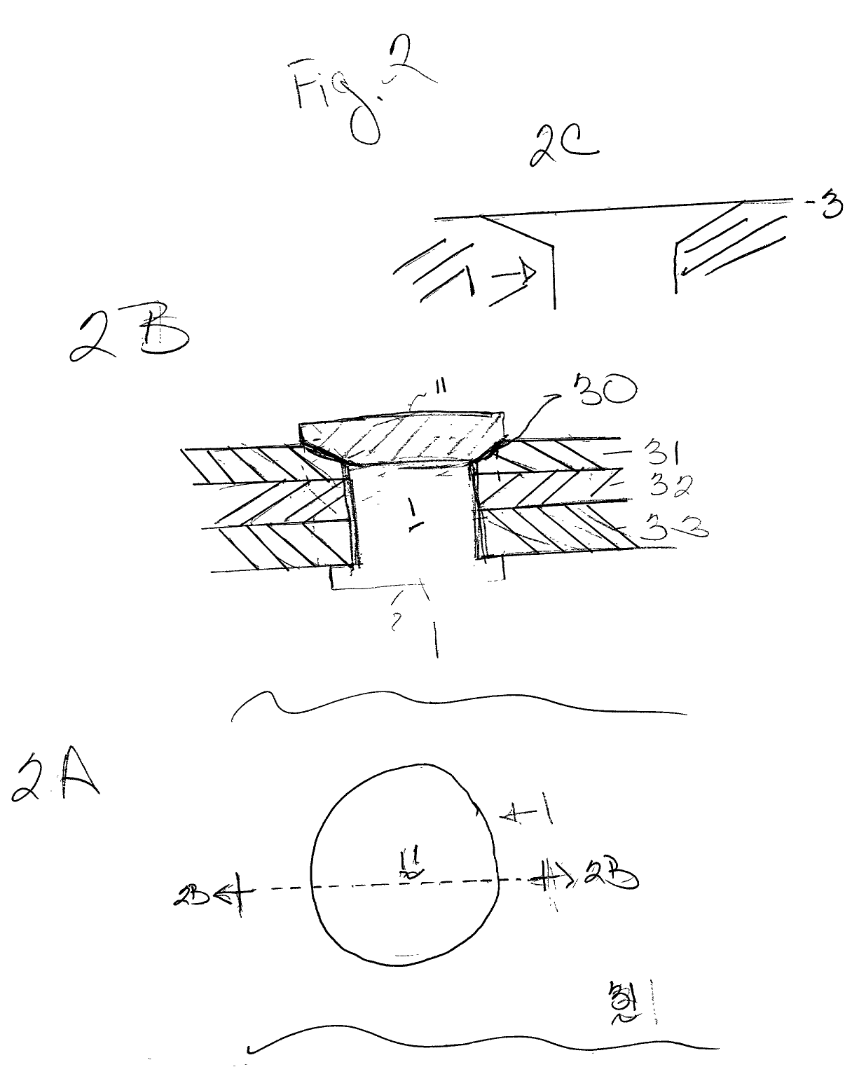

As shown in FIG. 1A, the fastener 1 of the present invention comprises head 10 and shank 20. The head 10 includes top 11, land 12, and countersink 13. As shown in FIGS. 2A and 2B, in use, the fastener 1 is placed into a countersink hole 30 formed in a structural element 31 such as the exterior paneling of an aircraft. Fastener I may be made entirely of high strength material, or, alternatively, as shown in FIG. 1B, a layer of material 100, may be bonded to head 10. Inertial welding has proven an effective means of joining material 100 to head 10. The layer of joined material 100 may be of a softer, more readily shavable material than the remainder of the fastener body. Alternatively, as discussed below, the layer of joined material 100 may be of a different color than the rest of the fastener.

As shown in FIG. 2B, a countersink hole 30 is formed through the first structural element 31 and proceeds down through a second structural element 32 or third structural element 33. The fastener 1 is inserted into the countersunk hole 30, thereby joining the structural elements. The fastener is sized to cause some portion of head 10 to extend beyond the surface of structural element 31. As shown best in FIG. 2C, the fastener is then shaved down so that it is flush with the surface of structural element 31 and an aerodynamically smooth surface is created. If too much material is removed from the head of the fastener during the shaving process, the fastener becomes weakened, which jeopardizes its ability to effectively join structural elements. The amount of material that can be shaved form the head of a fastener without weakening the fastener depends upon several factors including the strength of the material used to make the fastener and the load to which the fastener is subjected.

In order to show when the shaver has removed too much material from head 10 of the fastener, the fastener of the present invention contemplates several different types of indicators placed in land 12 and countersink 13. Different types and combinations of indicators may be used in the same fastener as required by the user. The embodiments of the invention which follow are those preferred at this time. However, other embodiments of the fastener of the present invention will be obvious to those of ordinary skill in the art.

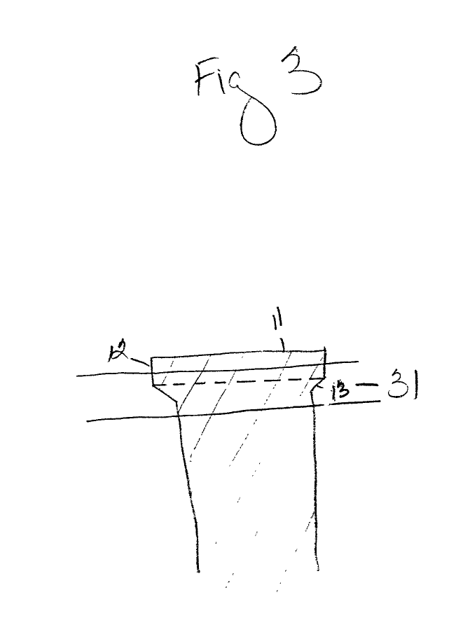

In one preferred embodiment of the invention, as shown in FIG. 3, the total land 12 is made available to be shaved. In this embodiment, the height of land 12 is calculated by first determining the height tolerance of the countersink hole 30 formed in the structural elements to be fastened. In the preferred embodiment of the fastener of the present invention, the height of land 12 is equal to the height tolerance of the countersink hole 30. For example, an aircraft fabricator is typically able to achieve a countersink height tolerance of +/−0.005″. Therefore, in this case, the height of land 12 should be 0.010″. As a result, a portion of land 12 would almost always extend beyond countersink hole 30. The portion of land 12 extending beyond the countersink hole 30 is then shaved to make the fastener flush.

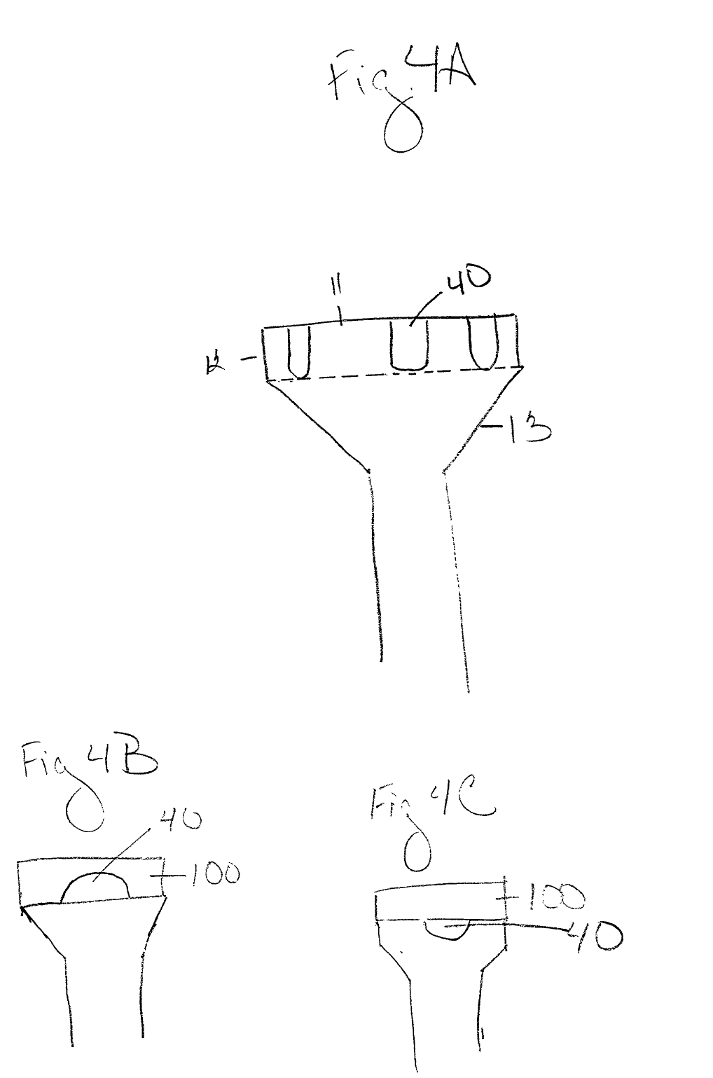

In another embodiment of the present invention, indicators are added to the top 11 of the fastener. As shown in FIG. 4A, these indicators could consist of one or more depressions 40 into the top surface of the fastener. Depressions 40 are set to a depth equal to the amount of head 10 which can be safely shaved. A successful shave operation removes material from the top surface of the fastener without completely erasing the depressions. As long as the depression or depressions were not completely erased by the shaving process, the user knows that he has not removed too much material from the head of the fastener, which would compromise fastener strength. The depressions may be left unfilled, or they can be filled with a material of contrasting color or texture. In the preferred form of this embodiment, the depressions are set equal to the total countersink height tolerance. Thus, some portion of the depressions should still be visible when the shaving process has been completed.

In the embodiment of the invention where a top layer of material 100 is joined to head 10, a depression or depressions 40 can be added to the joined surface of the material, as shown in FIG. 4B, or added to the joined surface of fastener body, as shown in FIG. 4C. In the embodiments of the invention shown in FIGS. 4B and 4C, as long as some depression remains detectable, the shaver knows that he has not removed too much material from the fastener head.

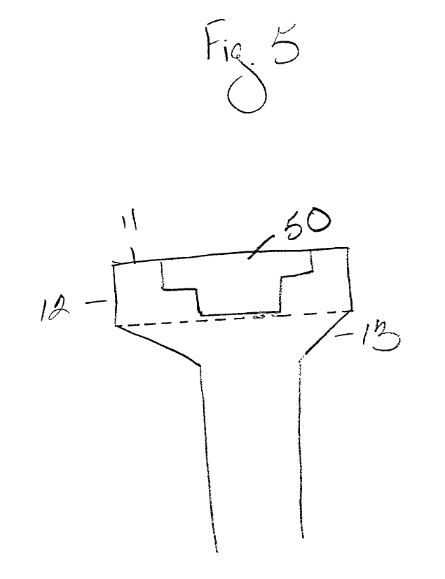

Alternatively, as shown in FIG. 5, a central, larger depression 50 could be formed in the top 11 of head 10. In this embodiment, the filler material can be staked by using a “tap root” configuration. Such an embodiment reduces the need for a strong adhesive to secure the filler material into the head of the fastener. Simple polymers, which may or may not be pigmented, and other liquid state adhesives could be used as filler material. Most preferably, the filler material should be electrically tailorable. Depression 50 is formed so that, as long as some depression remains detectable, the shaving operation has not removed too much material from the fastener.

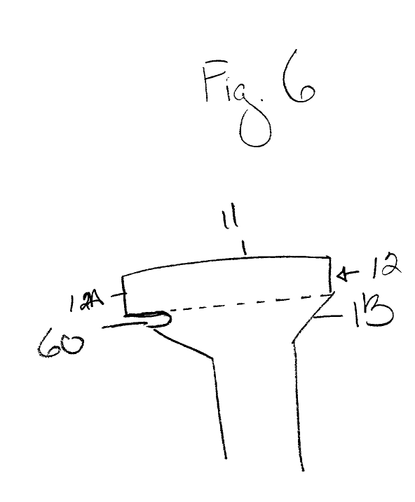

In yet another embodiment of the present invention, a horizontal depression or depressions 60 are added to the sides 12A of land 12 or to countersink 13. This embodiment is shown in FIG. 6. The indicators are so placed that when an excessive amount of material is removed from the fastener, these features are exposed. Thus, a successful shave operation would make the fastener flush with the surface without exposing countersink indicators. If the features are exposed, too much material has been removed, and the fastener should be discarded.

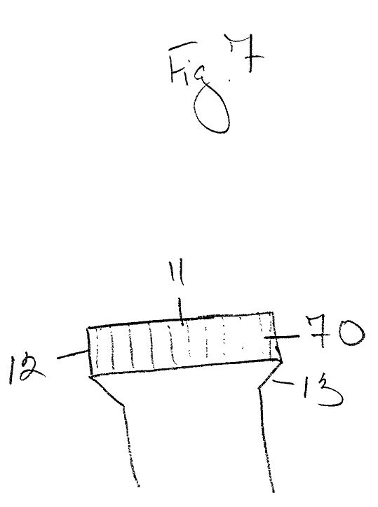

In another embodiment of the invention, shown in FIG. 7, machinable material 70 of a different color or texture would be installed on the head of the fastener such that when the shaver had removed all of the contrasting material, it would be apparent that too much material had been removed from the head of the fastener. In an alternate form of this embodiment, ions are implanted to a preselected depth, causing a color change in the treated portion of the head. The shaver would know he had removed too much material by the color change.

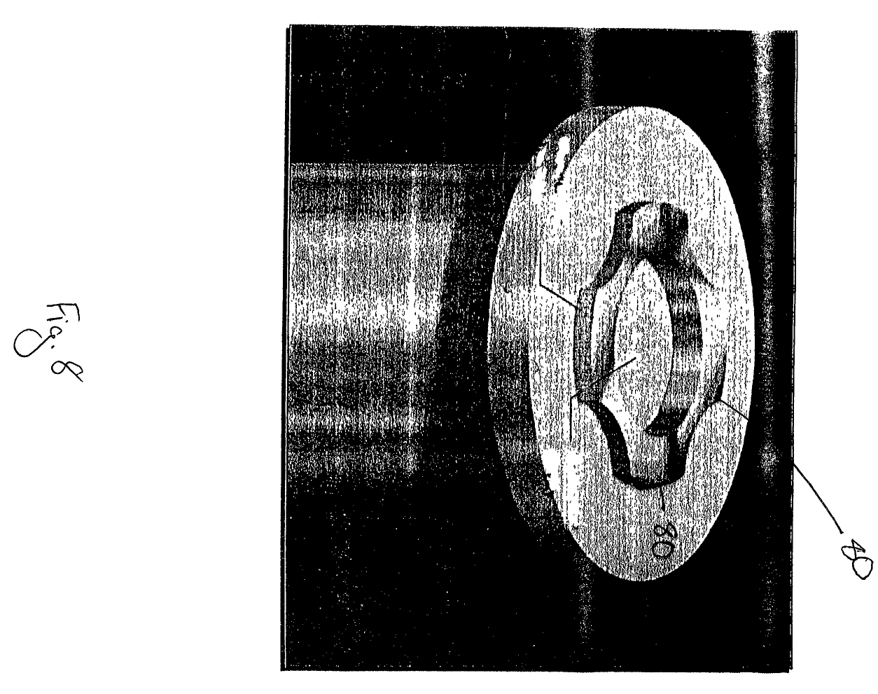

In a further embodiment of the invention, shown in FIG. 8, the fastener is formed to incorporate a wrenching device 80, which can be frangible. The fastener and wrenching device can then be shaved flush with the surface to be joined. The fastener head with wrenching device can be made to incorporate the means discussed above for indicating if too much material is removed from the fastener head during the shaving process.

I claim:

1. A fastener for connecting structural elements, said fastener intended to be shaved flush with the surface of one of said structural elements, said fastener having a head portion and a shank portion, said head portion comprising a top and countersink, and said head portion having means for indicating if too much material has been removed from said head portion.

2. The fastener of claim 1 wherein said top includes a land and said means for indicating if too much material has been removed from said head portion comprises manufacturing said land such that the land height is equal to the portion of said fastener that may be removed from said fastener without weakening the strength of said fastener.

3. The fastener of claim 1 wherein said means for indicating if too much material has been removed from said head portion comprises at least one depression in said head, the depth of said depression being equal to the portion of said fastener that may be removed from said fastener without weakening the strength of said fastener.

4. The fastener of claim 3 wherein said depression is filled with a contrasting material.

5. The fastener of claim 4 where said depression is made in the shape of a tap root.

6. The fastener of claim 4 wherein said contrasting material is a polymer.

7. The fastener of claim 6 wherein said polymer is pigmented.

8. The fastener of claim 1 wherein said means for indicating if too much material has been removed from said head portion comprises at least one depression in said countersink.

9. The fastener of claim 1 wherein said means for indicating if too much material has been removed from said head portion comprises bonding a layer of machinable material to said head portion, said layer of machinable material being equal to the portion of said fastener that may be removed from said fastener without weakening the strength of said fastener.

10. The fastener of claim 9 wherein said machinable material is of a different color than the remainder of said fastener.

11. The fastener of claim 9 wherein said machinable material is of a different texture than the remainder of said fastener.

12. The fastener of claim 1 wherein said means for indicating if too much material has been removed from said head portion comprises implanting ions in said head of said fastener to a depth equal to the portion of said fastener that may be removed from said fastener without weakening the strength of said fastener.

13. The fastener of claim 1 wherein said fastener incorporates a wrenching device.

14. A method for shaving a structural fastener flush with the surface of a structure to be joined, said fastener having a head portion and a shank portion, said head portion comprising a top and countersink, comprising the steps of:
(a) installing said fastener into a countersink hole in said structure to be joined;
(b) shaving material from the head of said fastener such that said fastener is made flush with said structure to be joined; and
(c) observing means for indicating whether too much material has been removed from said fastener.

15. The method of claim 14 wherein said top includes a land and said means for indicating if too much material has been removed from said fastener comprises manufacturing said land such that the land height is equal to the portion of said fastener that may be removed from said fastener without weakening the strength of said fastener.

16. The method of claim 14 wherein said means for indicating if too much material has been removed from said head portion comprises at least one depression in said head, the depth of said depression being equal to the portion of said fastener that may be removed from said fastener without weakening the strength of said fastener.

17. The method of claim 16 wherein said depression is filled with a contrasting material.

18. The method of claim 17 wherein said contrasting material is a polymer.

19. The method of claim 18 wherein said polymer is pigmented.

20. The method of claim 16 where said depression is made in the shape of a tap root.

21. The method of claim 14 wherein said means for indicating if too much material has been removed from said head portion comprises at least one depression in said countersink.

22. The method of claim 14 wherein said means for indicating if too much material has been removed from said head portion comprises bonding a layer of machinable material to said head portion, said layer of machinable material being equal to the portion of said fastener that may be removed from said fastener without weakening the strength of said fastener.

23. The method of claim 22 wherein said machinable material is of a different color than the remainder of said fastener.

24. The method of claim 22 wherein said machinable material is of a different texture than the remainder of said fastener.

25. The method of claim 14 wherein said means for indicating if too much material has been removed from said head portion comprises implanting ions in said land of said fastener to a depth equal to the portion of said fastener that may be removed from said fastener without weakening the strength of said fastener.

26. A method for detecting defects in the manufacturing of shavable fasteners and countersink holes in structural elements to be joined comprising the steps of:
(a) forming a fastener with means for indicating if too much material has been removed from said fastener during the shaving process;
(b) installing said fastener into a countersink hole formed in structural elements to be joined by said fastener;
(c) removing excess material from the top of said fastener by shaving said fastener so that said fastener is flush with the surface of said structural elements to be joined.

27. The method of claim 26 wherein said method for detecting defects further includes inspecting the flush fastener for the appearance of said means for indicating if too much material has been removed from said fastener during the shaving process.
